(19) United States
(12) Patent Application Publication
(10) Pub. No.: US 2014/0250167 A1
(43) Pub. Date: Sep. 4, 2014

(54) METHOD FOR MANAGNG TRANSMISSION INFORMATION AND ELECTRONIC DEVICE THEREOF

(71) Applicant: Samsung Electronics Co., Ltd., Gyeonggi-do (KR)

(72) Inventors: Sae-Mee Yim, Gyeonggi-do (KR); Soo-Ji Hwang, Gyeonggi-do (KR); Jin-Hong Jeong, Yongin-si (KR)

(73) Assignee: Samsung Electronics Co., Ltd., Gyeonggi-do (KR)

(21) Appl. No.: 14/197,042

(22) Filed: Mar. 4, 2014

(30) Foreign Application Priority Data
Mar. 4, 2013 (KR) 10-2013-0022957

(51) Int. Cl. H04L 29/08

(52) U.S. Cl. CPC H04L 67/1091
USPC 709/203

(57) ABSTRACT

A method and apparatus for managing transmission information about data in an electronic include transmitting data using a first application program, generating transmission information about the data transmitted using the first application program, and displaying the transmission information about the data.

### PRIORITY

The present application is related to and claims the benefit under 35 U.S.C. §119(a) of a Korean patent application filed in the Korean Intellectual Property Office on Mar. 4, 2013 and assigned Serial No. 10-2013-0022957, the entire disclosure of which is hereby incorporated by reference.

### TECHNICAL FIELD

The present disclosure relates to a method for managing transmission information and an electronic device thereof.

### BACKGROUND

Each of portable electronic devices has become each of necessities of modern people due to ease of carrying it. In addition, each of portable electronic devices has been developed into each of multimedia devices which provide various multimedia services using a data communication service as well as a voice communication service due to development of communication technologies.

Providing the multimedia service using the data communication service due to the development of the communication technologies, the portable electronic device may exchange various data with a counterpart electronic device. Herein, the various data include a Uniform Resource Locator (URL) address, a file, and the like.

However, the portable electronic device does not provide a service which separately manages data exchange information with the counterpart electronic device. Therefore, there is an inconvenience in that a user of the portable electronic device must memorize data exchange information with the counterpart electronic device one by one.

### SUMMARY

To address the above-discussed deficiencies, it is a primary object to provide a method and apparatus for managing transmission information in an electronic device.

Another aspect of the present disclosure is to provide a method and apparatus for managing transmission information about transmitted data using an application program in an electronic device.

Another aspect of the present disclosure is to provide a method and apparatus for managing transmission information about data transmitted through at least one application program using a transmission information management application program in an electronic device.

Another aspect of the present disclosure is to provide a method and apparatus for controlling data registered in a server using an application program which manages transmission information about data in an electronic device.

In accordance with an aspect of the present disclosure, a method of managing transmission information about data in an electronic device includes transmitting data using a first application program, generating transmission information about the data transmitted using the first application program, and displaying the transmission information about the data.

In accordance with another aspect of the present disclosure, an electronic device includes a display unit, at least one processor, a memory, and at least one program which is stored in the memory and is executed by at least the one processor. The at least the one processor is configured to transmit data using a first application program among at least the one program, generate transmission information about the transmitted data, and display the transmission information about the data on the display unit.

In accordance with another aspect of the present disclosure, a method of managing transmission information about data in an electronic device includes transmitting at least one data, generating at least one transmission information about at least the one data, displaying at least the one transmission information, and transmitting any one of deletion and correction control commands for at least one data corresponding to a control event to a server when the control event for at least one data transmitted to the server among at least the one data is generated.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of a configuration of an electronic device according to one embodiment of the present disclosure;

FIG. 2 illustrates a block diagram of a detailed configuration of a processor according to one embodiment of the present disclosure;

FIG. 3 illustrates a process of displaying transmission information in an electronic device according to one embodiment of the present disclosure;

FIG. 4 illustrates a signal sequence diagram of a process of managing transmission information about data in an electronic device according to one embodiment of the present disclosure;

FIG. 5 illustrates a process of managing transmission information about data in an application program of an electronic device according to one embodiment of the present disclosure;

FIG. 6 illustrates a signal sequence diagram of a process of managing transmission information about data using an information management application program in an electronic device according to one embodiment of the present disclosure;

FIG. 7 illustrates a process of transmitting transmission information about data in an application program of an electronic device according to one embodiment of the present disclosure;

FIG. 8 illustrates a process of managing transmission information in an information management program of an electronic device according to one embodiment of the present disclosure;

FIG. 9 illustrates a process of managing transmission information about data in a transmission program of an electronic device according to one embodiment of the present disclosure;

FIG. 10 illustrates a signal sequence diagram of a process of managing transmission information about data using an information management program in an electronic device according to another embodiment of the present disclosure;

FIG. 11 illustrates a process of transmitting transmission information about data in a transmission program of an electronic device according to one embodiment of the present disclosure;

FIG. 12 illustrates a process of managing transmission information about data in an information management program of an electronic device according to another embodiment of the present disclosure;

FIG. 13 illustrates a process of controlling data in an electronic device according to one embodiment of the present disclosure;

FIGS. 14A and 14B illustrate screens of a process of displaying transmission information in an electronic device according to one embodiment of the present disclosure; and

FIGS. 15A and 15B illustrate screens of a process of displaying transmission information in an electronic device according to another embodiment of the present disclosure.

### DETAILED DESCRIPTION

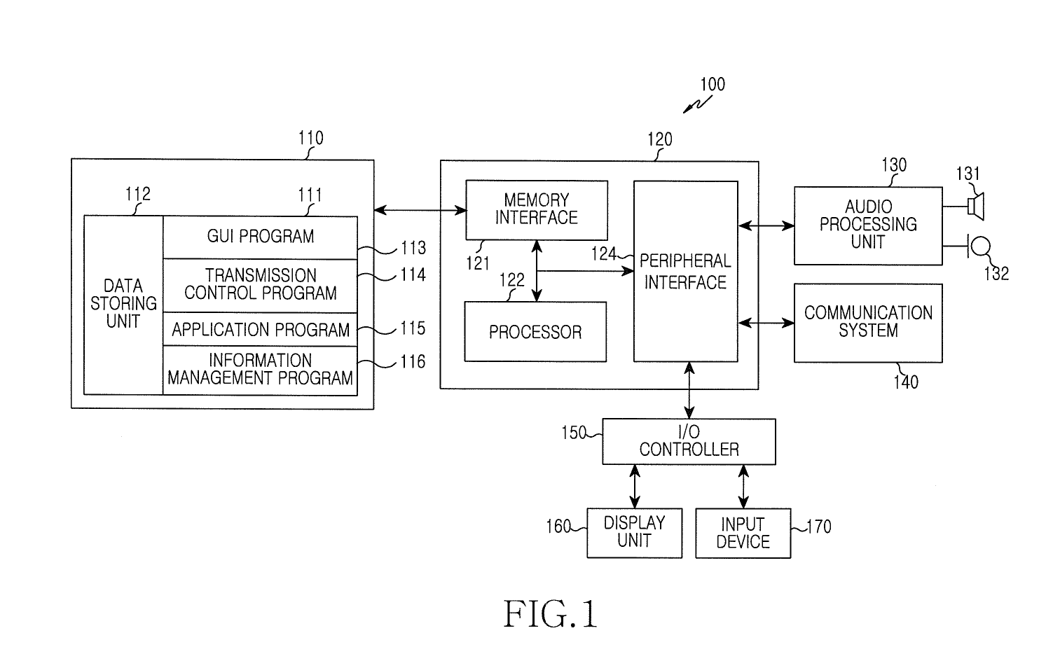

FIGS. 1 through 15B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or method. Example embodiments of the present disclosure will be described herein below with reference to the accompanying drawings. In the following description, well-known functions or constructions are not described in detail since they would obscure the disclosure in unnecessary detail.

Hereinafter, a description will be given for a method and apparatus for managing transmission information about data in an electronic device.

Hereinafter, the electronic device includes one or more of a mobile communication terminal, a Personal Digital Assistant (PDA), a Personal Computer (PC), a laptop computer, a smart phone, a netbook, a television, a Mobile Internet Device (MID), a Ultra Mobile Personal Computer (UMPC), a tablet PC, a navigation device, a smart TV, and a Moving Picture Experts Group (MPEG) layer 3 (MP3) player.

FIG. 1 illustrates a block diagram of a configuration of an electronic device according to one embodiment of the present disclosure.

As shown in FIG. 1, the electronic device denoted by 100 may include a memory 110, a processor unit 120, an audio processing unit 130, a communication system 140, an Input/Output (I/O) controller 150, a display unit 160, and an input device 170. Herein, the memory 110 may be a plurality of memories.

A description will be given for each component as follows.

The memory 110 may include a program storing unit 111 for storing programs for controlling operations of the electronic device 100 and a data storing unit 112 for storing data generated while the programs are executed.

The data storing unit 112 stores transmission information about data transmitted to a counterpart electronic device or a server. For example, the data storing unit 112 may store the transmission information about the data as a table type. Herein, the transmission information may include at least one of a transmission target of the data, a transmission time of the data, a kind of the data, information about a transmission program which transmits the data, and information about an application program which requests transmission of the data.

The program storing unit 111 includes a Graphic User Interface (GUI) program 113, at least one transmission control program 114, and at least one application program 115. Herein, the programs included in the program storing unit 111 may be expressed in an instruction set as a set of instructions. For one example, when the electronic device 100 includes a plurality of transmission control programs 114, the processor 122 of the electronic device 100 may transmit data using any one transmission control program according to a characteristic of a transmission event among the plurality of transmission control programs 114. For another example, when the electronic device 100 includes a plurality of transmission control programs 114, the processor 122 of the electronic device 100 may transmit data using any one transmission control program selected according to input information provided from the input device 170 among the plurality of transmission control programs 114.

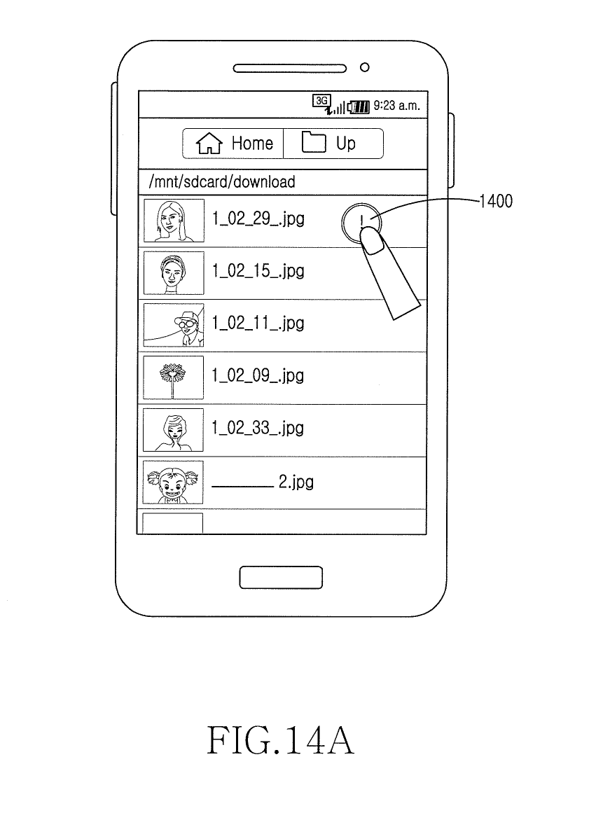

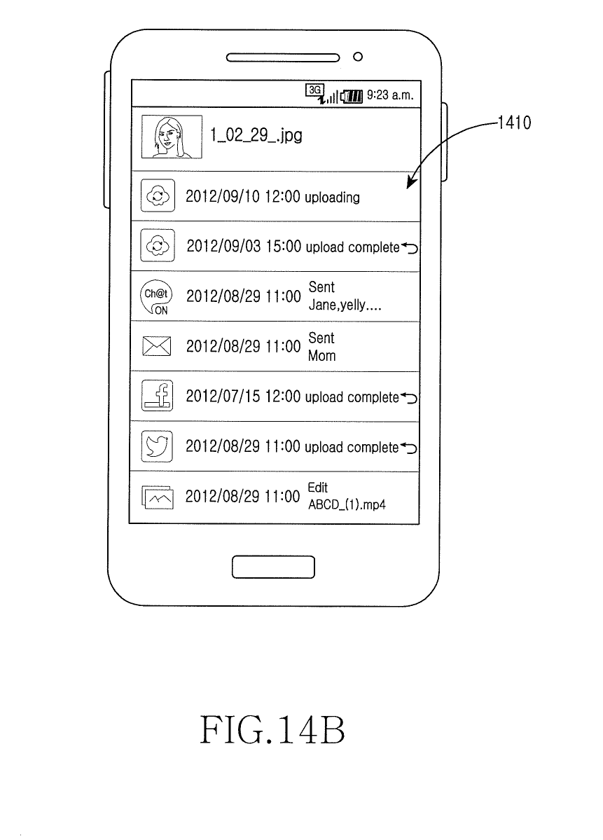

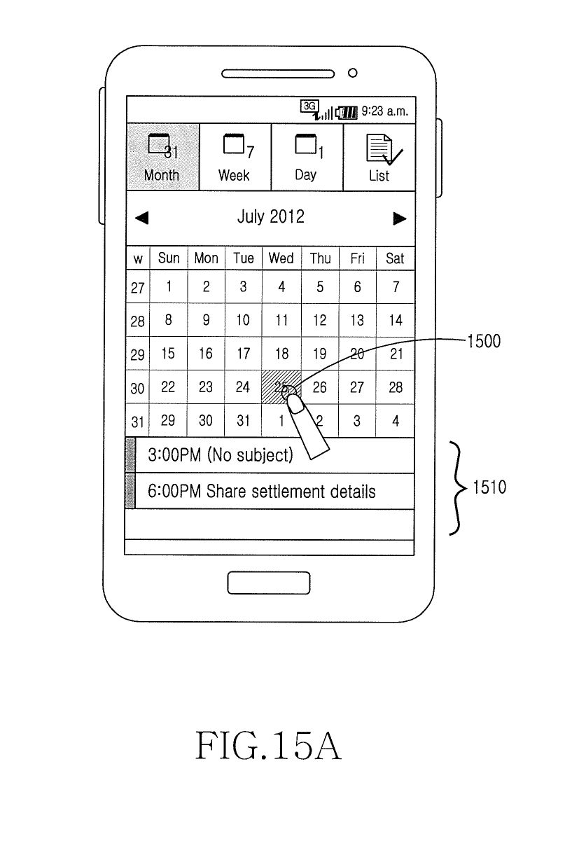

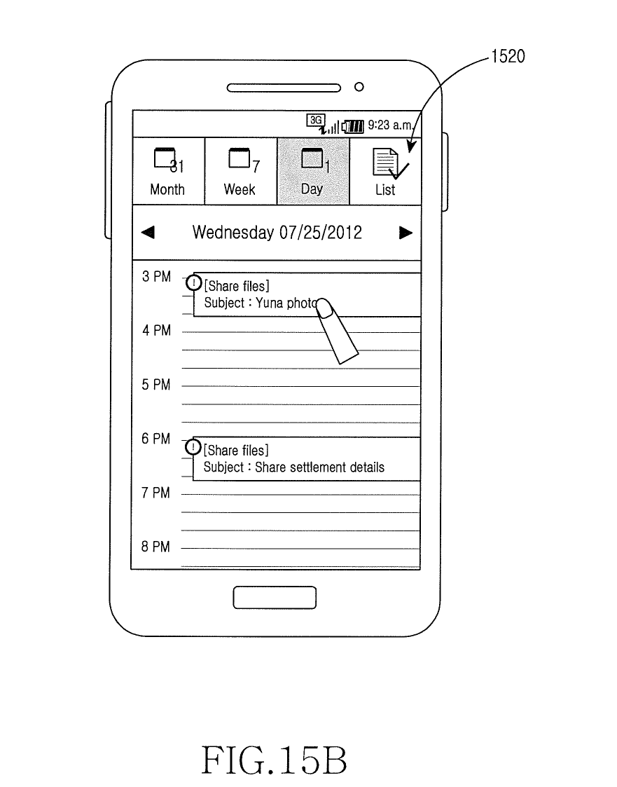

The GUI program 113 includes at least one software component for providing a UI as graphics on the display unit 160. For example, the GUI program 113 controls the display unit 160 to display information of an application program executed by the processor 122. Herein, as shown in FIGS. 14A and 14B or FIGS. 15A and 15B, the GUI program 113 may control the display unit 160 to display transmission information about data according to the application program 115 which is being executed.

The transmission control program 114 includes at least one software component for controlling transmission of data. For one example, the transmission control program 114 may perform a control operation to transmit data to a counterpart electronic device or a server according to a request of the application program 115 which is being executed. Herein, the transmission control program 114 may transmit a data transmission completion signal to an application program for managing information or an application program for requesting transmission of data among at least the one application program 115 to generate transmission information about data. For another example, when a transmission event is generated, the transmission control program 114 may perform a control operation to extract data corresponding to the transmission event and transmit the extracted data to the counterpart electronic device or the server. Herein, the transmission control program 114 may transmit a data transmission completion signal to an application program for managing information to generate transmission information about data.

The application program 115 includes a software component for at least one application program installed in the electronic device 100. For example, when a transmission event for data is generated, the application program 115 may request the transmission control program 114 to transmit data corresponding to the transmission event. If the electronic device 100 includes the plurality of transmission control programs 114, the application program 115 may select any one transmission control program 114 to request transmission of data according to a characteristic of a transmission event or input information provided from the input device 170. When the data transmission completion signal is received from the transmission control program 14, the application program 115 may generate transmission information of data for the data transmission completion signal. In addition, the application program 115 may perform a control operation to transmit transmission information of data to an information management program 116. Also, the application program 115 may execute data according to a request of the information management program 116.

The application program 115 may control data transmitted to the server according to input information provided from the input device 170 using transmission information stored in the data storing unit 112. For one example, the application program 115 may identify data transmitted to a cloud server using transmission information stored in the data storing unit 112. Thereafter, the application program 115 may change, correct, or delete the data transmitted to the cloud server through a background operation. Herein, the application program 115 may control data using an identifier of the data in the cloud server, which is recognized when transmitting the data to the cloud server. For another example, the application program 115 may identify data transmitted to a Social Network Service (SNS) server using transmission information stored in the data storing unit 112. Thereafter, the application program 115 may change, correct, or delete data transmitted to the SNS server through a background operation. Herein, the application program 115 may control data using an identifier of sharing data in the SNS server, which is recognized when transmitting the data to the SNS server.

In addition, the program storing unit 111 may include the information management program 116. Herein, the information management program 116 may be at least one of application programs, such as a scheduler, a diary, and a phonebook, for managing data among at least one application program 115 installed in the electronic device 100.

The information management program 116 includes at least one software component for managing data according to the driving of the electronic device 100. The information management program 116 may add transmission information on a management information list. For one example, the information management program 116 may perform a control operation to generate transmission information about data according to the data transmission completion signal provided from the transmission control program 114 and add and store the generated transmission information to the corresponding data. For another example, the information management program 116 may perform a control operation to add and store transmission information to corresponding data according to the transmission information about the data provided from the application program 115. Herein, the management information list as a data list managed in the information management program 116 may include schedule information, diary information, contact information, and the like.

The information management program 116 may control data transmitted to the server according to input information provided from the input device 170 using transmission information stored in the data storing unit 112.

The processor unit 120 may include a memory interface 121, at least one processor 122, and a peripheral interface 124. Herein, the memory interface 121, at least one processor 122, and the peripheral interface 124 which are included in the processor unit 120 may be integrated in at least one Integrated Circuit (IC) or be separately implemented.

The memory interface 121 controls that a component like the processor 122 or the peripheral interface 124 accesses the memory 110.

The peripheral interface 124 controls connection among an I/O peripheral of the electronic device 100, the processor 122, and the memory interface 121.

The processor 122 provides a variety of multimedia services using at least one software program. Herein, the processor 122 executes at least one program stored in the memory 110 and provides a service according to the corresponding program. For example, the processor 122 may execute at least the one application program 115 and the information management program 116 which are stored in the program storing unit 111 and generate transmission information about data transmitted to the counterpart electronic device or the server.

The audio processing unit 130 provides an audio interface between a user and the electronic device 100 through a speaker 131 and a microphone 132.

The communication system 140 performs a communication function for voice and data communication. For example, the communication system 140 may be classified into a plurality of communication sub-modules which support different communication networks. For example, the communication network may include, but is not limited to, any one of a Global System for Mobile communication (GSM) network, an Enhanced Data GSM Environment (EDGE) network, a Code Division Multiple Access (CDMA) network, a W-CDMA network, a Long Term Evolution (LIE) network, an Orthogonal Frequency Division Multiple Access (OFDMA) network, a wireless Local Area Network (LAN), a Bluetooth network, a Near Field Communication (NFC) network, and the like.

The I/O controller 150 provides an interface between I/O devices, such as the display device 160 and the input device 170, and the peripheral interface 124.

The display unit 160 displays state information of the electronic device 100, characters input by the user, moving pictures, still pictures, and the like. For example, the display unit 160 may display information of an application program executed by the processor 122. As shown in FIG. 14A, displaying a photo list, the display unit 160 may display transmission information 1400 on a photo included in the photo list. When selection of the transmission information 1400 is sensed, the display unit 160 may display, as shown in FIG. 14B, detailed transmission information 1410 about a corresponding photo file. Alternatively, as shown in FIG. 15A, displaying schedule information, the display unit 160 may display transmission information 1510 together with schedule information about a specific date 1500 (e.g., Jul. 25, 2012). When selection of the schedule information about the specific date 1500 is sensed, the display unit 160 may display schedule information including detailed transmission information 1520 about data of the specific date 1500, which is shown in FIG. 15B.

The input device 170 provides input data generated by selection of the user to the processor unit 120 through the I/O controller 150. Herein, the input device 170 may include a keypad including at least one hardware button, a touch pad for sensing touch information, and the like.

In the above-described one embodiment of the present disclosure, the processor 122 may execute the software components stored in the program storing unit 111 in one module and generate transmission information about data transmitted to the counterpart electronic device or the server.

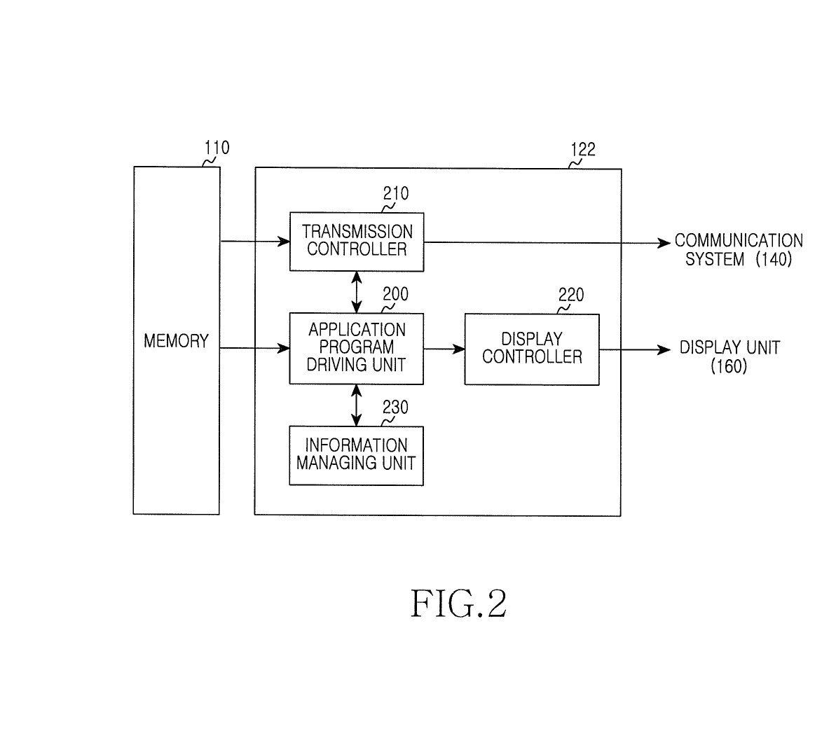

In another embodiment of the present disclosure, the processor 122 may include, as shown in FIG. 2, separate modules for generating transmission information about data transmitted to the counterpart electronic device or the server.

FIG. 2 illustrates a block diagram of a detailed configuration of a processor according to one embodiment of the present disclosure.

As shown in FIGS. 1 and 2, the processor 122 includes an application program driving unit 200, a transmission controller 210, and a display controller 220.

The application program driving unit 200 executes at least the one application program 115 stored in the program storing unit 111 and provides a service according to the corresponding application program. For example, when a transmission event for data is generated, the application program driving unit 200 may request the transmission controller 210 to transmit the corresponding data. If the transmission controller 210 may execute the plurality of transmission control programs 114, the application program driving unit 200 may select the transmission control program 114 to be used for transmitting data according to a characteristic of a transmission event or input information provided from the input device 170. When a data transmission completion signal is received from the transmission controller 210, the application program driving unit 200 may generate transmission information of data for the data transmission completion signal. In addition, the application program driving unit 200 may transmit transmission information of data to an information managing unit 230. In this embodiment, the application program driving unit 200 may execute data according to transmission information according to a request of the information managing unit 230.

The application program driving unit 200 may control data transmitted to a server according to input information provided from the input device 170 using transmission information stored in the data storing unit 112. For one example, the application program driving unit 200 may identify data transmitted to a cloud server using transmission information stored in the data storing unit 112. Thereafter, the application program driving unit 200 may change, correct, or delete the data transmitted to the cloud server through a background operation. Herein, the application program driving unit 200 may control data using an identifier of the data in the cloud server, which is recognized when transmitting the data to the cloud server. For another example, the application program driving unit 200 may identify data transmitted to an SNS server using transmission information stored in the data storing unit 112. Thereafter, the application program driving unit 200 may change, correct, or delete the data transmitted to the SNS server through a background operation. Herein, the application program driving unit 200 may control data using an identifier of the data in the SNS server, which is recognized when the transmission controller 210 transmits the data to the SNS server.

The transmission controller 210 executes the transmission control program 114 stored in the program storing unit 111 and controls transmission of data. For one example, the transmission controller 210 may transmit data to a counterpart electronic device or a server according to a request of the application program driving unit 200 through the communication system 140. Herein, the transmission controller 210 may transmit a data transmission completion signal to the information managing unit 230 or the application program driving unit 200 to generate transmission information about data. For another example, the transmission controller 210 may extract data according to a transmission event for the transmission control program 114 which is being executed and transmit the extracted data to the counterpart electronic device or the server through the communication system 140. Herein, the transmission controller 210 may transmit a data transmission completion signal to the information managing unit 230 to generate transmission information about data.

In addition, the processor 122 may include the information managing unit 230. Herein, the information managing unit 230 may execute the information management program 116, such as a scheduler, a diary, and a phonebook, among at least one application program 115 included in the program storing unit 111 and manage data according to driving of the electronic device 100.

The information managing unit 230 may add and manage transmission information about data on a management information list. For one example, the information managing unit 230 may perform a control operation to generate transmission information about data according to the data transmission completion signal provided from the transmission controller 210 and add and store the generated transmission information to the corresponding data. For another example, the information managing unit 230 may perform a control operation to add and store transmission information to corresponding data according to transmission information about the data provided from the application program driving unit 200.

The information managing unit 230 may control data transmitted to the server according to input information provided from the input device 170 using transmission information stored in the data storing unit 112.

The display controller 220 may execute the GUI program 113 stored in the program storing unit 111 and control the display unit 160 to display a UI as graphics. For example, the display controller 220 controls the display unit 160 to display information of an application program executed by the application program driving unit 200. Herein, as shown in FIGS. 14A and 14B or FIGS. 15A and 15B, the display controller 220 may control the display unit 160 to display transmission information about data according to the application program 115 which is being executed.

In the above-described one embodiment of the present disclosure, the electronic device 100 may generate the transmission information about the data transmitted to the counterpart electronic device or the server using the application program driving unit 200 or the information managing unit 230.

In another embodiment of the present disclosure, the electronic device 100 may generate transmission information about data transmitted to the counterpart electronic device or the server using the transmission controller 210. In this embodiment, the application program driving unit 200 may perform a control operation to display transmission information of data together when driving the application program 115 according to the transmission information about the data which is generated by the transmission controller 210 and is then stored in the data storing unit 112.

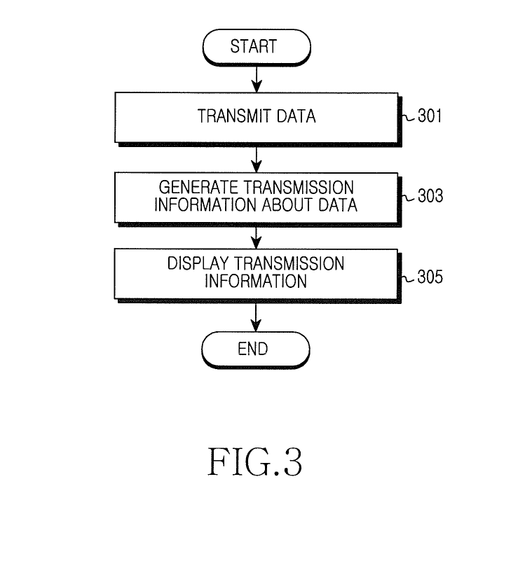

FIG. 3 illustrates a process of displaying transmission information in an electronic device according to one embodiment of the present disclosure.

Referring to FIGS. 1 and 3, when a transmission event is generated, the electronic device 100 transmits data according to the transmission event to a counterpart electronic device or a server in operation 301. For one example, when a transmission event for a first photo file is generated on a photo list displayed on the display unit 160, the electronic device 100 determines the transmission control program 114 for transmitting the first photo file. Thereafter, the electronic device 100 may transmit the first photo file to the counterpart electronic device or the server using the corresponding transmission control program 114. For another example, when a messenger program is executed, the electronic device 100 may transmit data to the counterpart electronic device according to input information provided from the input device 170. For another example, when an SNS program is executed, the electronic device 100 may transmit data to an SNS server according to input information provided from the input device 170. For another example, when data are updated according to driving of the electronic device 100, the electronic device 100 may transmit the updated data to a cloud server.

Thereafter, the electronic device 100 proceeds to operation 303 and generates transmission information about the data. For example, the electronic device 100 may generate transmission information about data transmitted to the counterpart electronic device or the server using the application program 115, the transmission control program 114, or the information management program 116 in which a transmission event is generated. Herein, the electronic device 100 may store the transmission information about the data as a table type. Herein, the transmission information about the data may include at least one of a transmission target of the data, a transmission time of the data, a kind of the data, information about a transmission program which transmits the data, and information about an application program which requests transmission of the data.

After generating the transmission information about the data, the electronic device 100 proceeds to operation 305 and displays the transmission information on the display unit 160. For one example, when a photo management program is executed, the electronic device 100 displays, as shown in FIG. 14A, at least one photo file list stored in the data storing unit 112 on the display unit 160. Herein, the electronic device 100 may display a transmission icon 1400 on a photo file including transmission information among photo file lists. In addition, when selection of the transmission icon 1400 is sensed, the electronic device 100 may display, as shown in FIG. 14B, detailed transmission information 1410 about data. For another example, when a scheduler is executed, the electronic device 100 displays, as shown in FIG. 15A, previously generated schedule information on the display unit 160. Herein, the electronic device 100 may display transmission information 1500 which is classified according to days. In addition, the electronic device 100 may display transmission information about a specific date on a lower end 1510 of schedule information. Also, when selection of a date 1500 on which transmission information is displayed is sensed, the electronic device 100 may display, as shown in FIG. 15B, detailed transmission information 1520 about data.

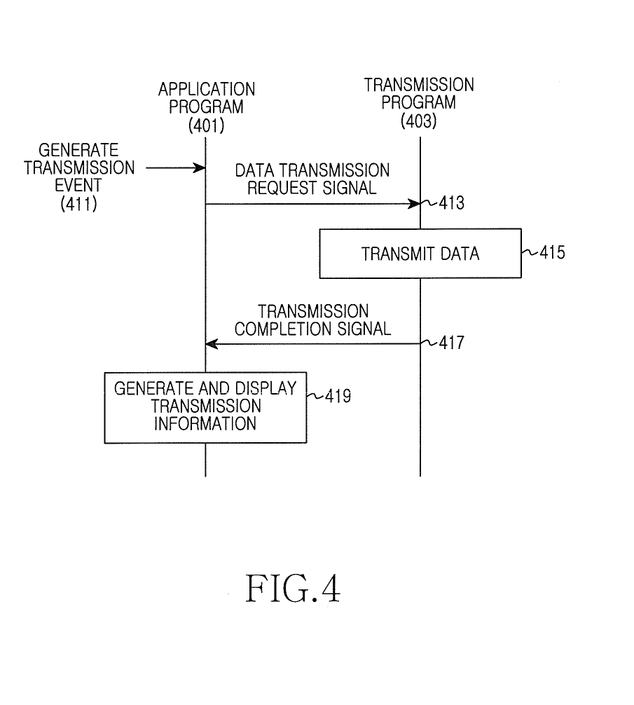

FIG. 4 illustrates a signal sequence diagram of a process of managing transmission information about data in an electronic device according to one embodiment of the present disclosure.

Hereinafter, a description will be given for transmitting and receiving signals at an application program and a transmission program which are installed in the electronic device. Also, an application program driving unit for executing an application program and a transmission controller for executing a transmission program may transmit and receive signals according to configuration of the electronic device.

As shown in FIG. 4, when a transmission event is generated while an application program 401 of the electronic device is executed (operation 411), the application program 401 requests a transmission program 403 to transmit data according to the transmission event (operation 413). If the electronic device includes a plurality of transmission programs, the application program 401 may request the transmission program 403 determined by a characteristic of a transmission event or an input signal provided form an input device to transmit data.

The transmission program 403 transmits specific data to a server or a counterpart electronic device according to the request of the application program 401 (operation 415). When the transmission of the data is completed, the transmission program 403 transmits a data transmission completion signal to the application program 401 (operation 417).

When the data transmission completion signal is received from the transmission program 403, the application program 401 generates transmission information about the data which is requested to the transmission program to be transmitted (operation 419).

As shown in FIG. 14A, if a photo list is displayed as a service screen according to the application program 401 on a display unit of the electronic device, the electronic device may display the transmission information on a photo file transmitted to the counterpart electronic device or the server through the transmission program 403 among photo lists.

In the above-described one embodiment of the present disclosure, the application program 401 may generate the transmission information about the data transmitted to the server or the counterpart electronic device using the data transmission completion signal provided from the transmission program 403.

In another embodiment of the present disclosure, the transmission program 403 may generate transmission information about data transmitted to the counterpart electronic device or the server.

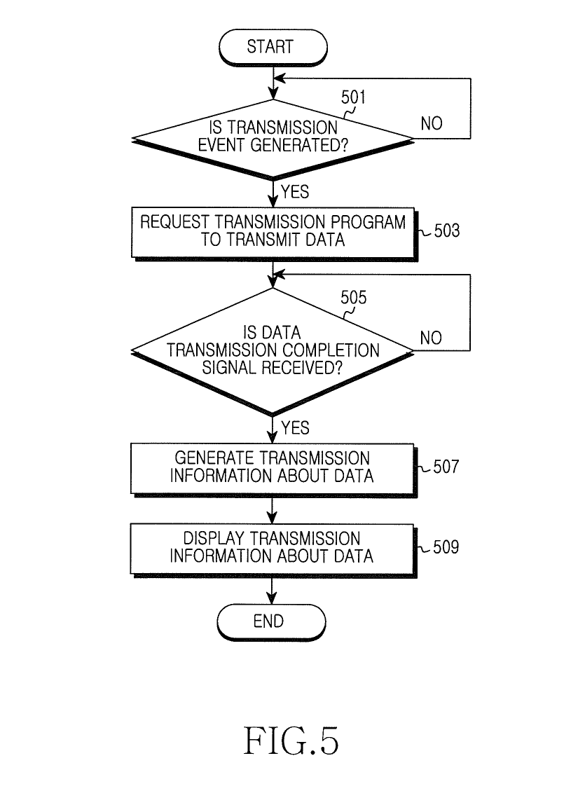

FIG. 5 illustrates a process of managing transmission information about data in an application program of an electronic device according to one embodiment of the present disclosure.

Referring to FIG. 5, the application program of the electronic device identifies whether a transmission event is generated while being executed in operation 501. For example, the electronic device may identify whether a transmission menu for a specific file is selected according to input information provided from an input device.

When the transmission event is generated, the application program proceeds to operation 503 and requests a transmission program to transmit data selected by the transmission event. If a plurality of transmission programs are installed in the electronic device, the application program may request any one transmission program determined by a characteristic of a transmission event or input information provided from the input device among the plurality of transmission programs to transmit data.

Thereafter, the application program proceeds to operation 505 and identifies whether a data transmission completion signal is received from the transmission program which is requested to transmit the data. Not receiving the data transmission completion signal during a reference time after requesting the transmission program to transmit the data, the application program may request the transmission program again to transmit the corresponding data.

Receiving the data transmission completion signal from the transmission program, the application program proceeds to operation 507 and generates transmission information about the data which are requested to the transmission program to be transmitted. Herein, the application program may store the transmission information about the data in a data storing unit.

When a service for the application program is provided, the application program may proceed to operation 509 and display the transmission about the data together on a service screen for the application program. For example, the application program may control, as shown in FIG. 14A, the display unit to display a service screen according to the application program including transmission information.

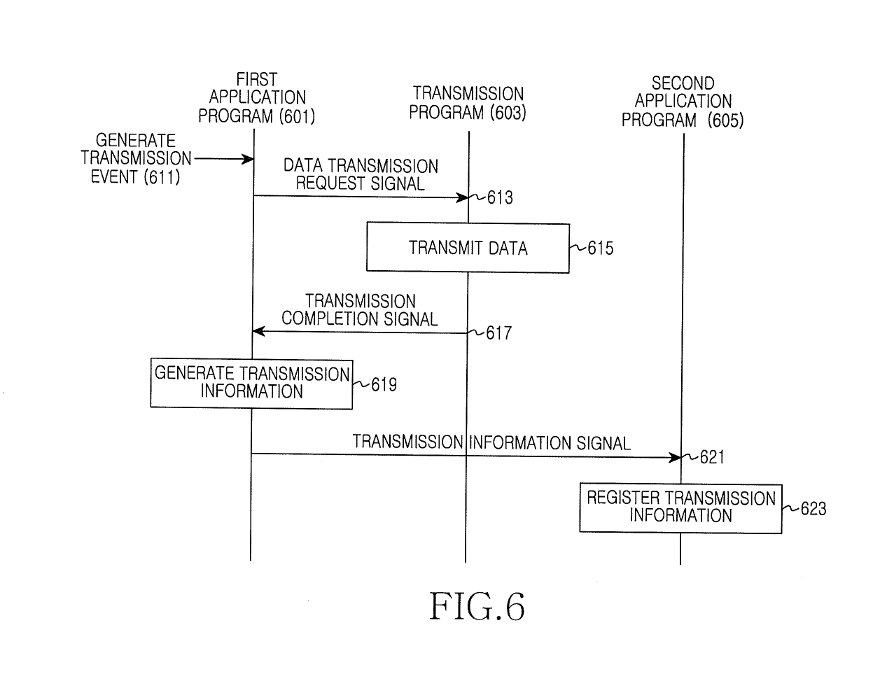

FIG. 6 illustrates a signal sequence diagram of a process of managing transmission information about data using an information management application program in an electronic device according to one embodiment of the present disclosure.

Hereinafter, a description will be given for transmitting and receiving signals at a first application program, a transmission program, and a second application program which are installed in the electronic device. Also, an application program driving unit for executing a first application program, a transmission controller for executing a transmission program, and an information managing unit for executing a second application program may transmit and receive signals according to configuration of the electronic device.

As shown in FIG. 6, when a transmission event is generated while a first application program 601 of the electronic device is executed (operation 611), the first application program 601 requests a transmission program 603 to transmit data according to the transmission event (operation 613). If the electronic device includes a plurality of transmission programs, the first application program 601 may request the transmission program 603 determined by a characteristic of a transmission event or an input signal provided form an input device to transmit data.

The transmission program 603 transmits specific data to a server or a counterpart electronic device according to the request of the first application program 401 (operation 615). When the transmission of the data is completed, the transmission program 603 transmits a data transmission completion signal to the first application program 601 (operation 617).

Receiving the data transmission completion signal from the transmission program 603, the first application program 601 generates transmission information about the data which is requested to the transmission program 603 to be transmitted (operation 619). As shown in FIG. 14A, if a photo list is displayed as a service screen according to the first application program 601 on a display unit of the electronic device, the electronic device may display the transmission information on a photo file transmitted to the counterpart electronic device or the server through the transmission program 603 among photo lists.

Thereafter, the first application program 601 transmits the transmission information about the data to a second application program 605 (operation 621). Herein, the transmission information may include at least one of a transmission target of the data, a transmission time of the data, a kind of the data, information about a transmission program which transmits the data, and information about an application program which requests the transmission of the data.

The second application program 605 registers the transmission information provided from the first application program 601 in a management information list. For one example, managing schedule information, the second application program 605 may add transmission information to the schedule information. For another example, managing diary information of a user, the second application program 605 may add the transmission information to the diary information of the user. For another example, managing phonebook information, the second application program 605 may add the transmission information to phonebook data.

As shown in FIG. 15A, when schedule information is displayed as a service screen according to the second application program 605 on the display unit, the electronic device may display schedule information 1500 including transmission information on the display unit.

In the above-described one embodiment of the present disclosure, the transmission program transmits the data transmission completion signal to the first application program 601. Accordingly, the first application program 601 may generate the transmission information about the data transmitted to the counterpart electronic device or the server through the transmission program 603.

In another embodiment of the present disclosure, the transmission program 603 may transmit a data transmission completion signal to the second application program 605. Accordingly, the second application program 605 may generate transmission information about data transmitted to the counterpart electronic device or the server through the transmission program 603 and add the generated transmission information on a management information list.

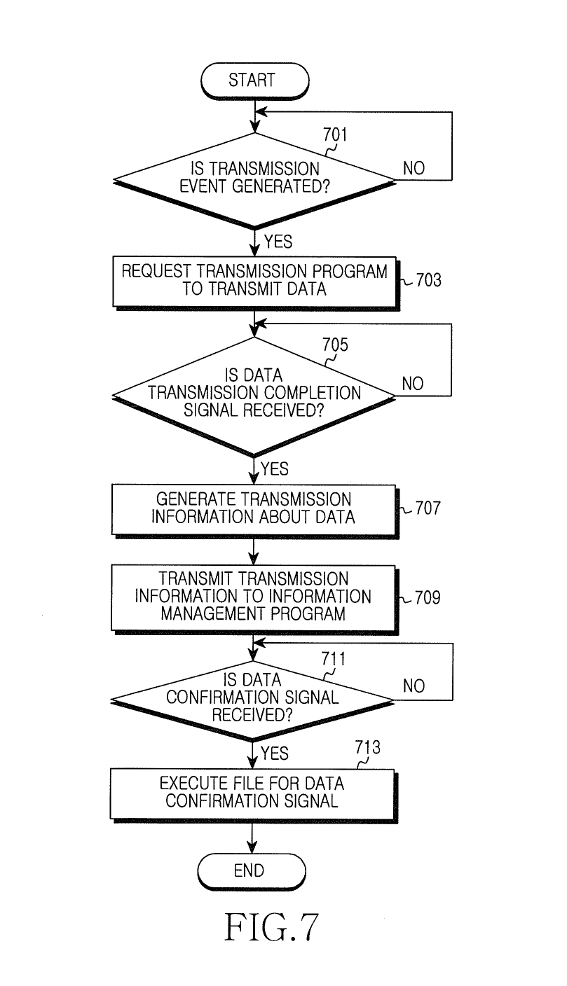

FIG. 7 illustrates a process of transmitting transmission information about data in an application program of an electronic device according to one embodiment of the present disclosure.

Referring to FIG. 7, the application program of the electronic device identifies whether a transmission event is generated while being executed in operation 701. For example, the electronic device may identify whether a transmission menu for a specific file is selected according to input information provided from an input device.

When the transmission event is generated, the application program proceeds to operation 703 and requests a transmission program to transmit data selected by the transmission event. If a plurality of transmission programs are installed in the electronic device, the application program may request any one transmission program determined by a characteristic of a transmission event or input information provided from the input device among the plurality of transmission programs to transmit data.

Thereafter, the application program proceeds to operation 705 and identifies whether a data transmission completion signal is received from the transmission program which is requested to transmit the data. Not receiving the data transmission completion signal during a reference time after requesting the transmission program to transmit the data, the application program may request the transmission program again to transmit the corresponding data.

Receiving the data transmission completion signal from the transmission program, the application program proceeds to operation 707 and generates transmission information about the data which are requested to the transmission program to be transmitted. Herein, the application program may store the transmission information about the data in a data storing unit.

After generating the transmission information, the application program proceeds to operation 709 and transmits the transmission information to an information management program. Herein, the transmission information may include at least one of a transmission target of the data, a transmission time of the data, a kind of the data, information about a transmission program which transmits the data, and information about an application program which requests transmission of the data.

In addition, the application program proceeds to operation 711 and identifies whether a data confirmation signal is received from the information management program.

Receiving the data confirmation signal, the application program proceeds to operation 713 and executes data for the data confirmation signal. For one example, receiving a confirmation signal for a photo file transmitted to a counterpart electronic device or a server from the information management program, the application program may display the photo file transmitted to the counterpart electronic device or the server on a display unit. For another example, receiving a confirmation signal for a URL address transmitted to the server from the information management program, the application program may display a webpage of the URL address transmitted to the server on the display unit.

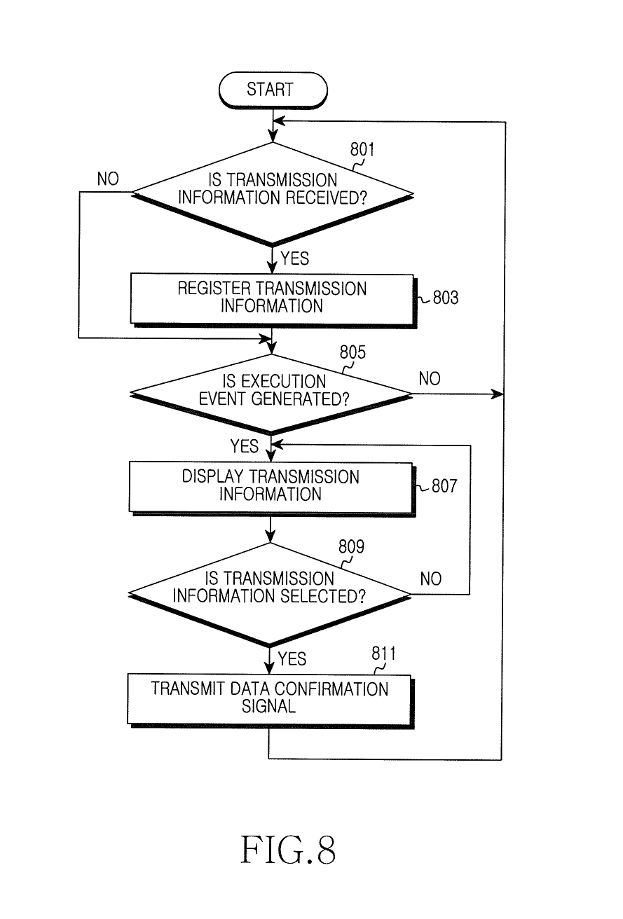

FIG. 8 illustrates a process of managing transmission information in an information management program of an electronic device according to one embodiment of the present disclosure.

Referring to FIG. 8, the information management program of the electronic device identifies whether transmission information about data is received from an application program in operation 801.

Not receiving the transmission information, the information management program proceeds to operation 805 and identifies whether an execution event is generated. For example, the information management program identifies whether its selection is sensed by input information provided from an input device.

Alternatively, receiving the transmission information, the information management program proceeds to operation 803 and adds the transmission information provided from the application program on its management information list. For one example, managing schedule information, the information management program may add the transmission information to the schedule information. For another example, managing diary information of a user, the information management program may add the transmission information to the diary information of the user. For another example, managing phonebook information, the information management program may add the transmission information to counterpart electronic device information included in a phonebook.

Thereafter, the information management program proceeds to operation 805 and identifies whether an execution event is generated. For example, the information management program identifies whether its selection is sensed by input information provided from the input device.

When the execution event is not sensed, the information management program proceeds to operation 801 and identifies whether transmission information about data is received from the application program.

Alternatively, when the execution event is sensed, the information management program proceeds to operation 807 and displays the transmission information about the electronic device. For example, managing scheduler information, the information management program may control, as shown in FIG. 15A, a display unit to display schedule information 1500 including transmission information. In addition, the information management program may control the display unit to display transmission information about a specific date on a lower end 1510 of schedule information. Also, when schedule information 1500 (e.g., a date) in which transmission information is displayed is selected, the information management program may control, as shown in FIG. 15B, the display unit to display transmission information 1520 about at least one data which is transmitted to a counterpart electronic device or a server at a specific date.

In addition, the information management program proceeds to operation 809 and identifies whether selection of at least one transmission information is sensed among transmission information displayed on the display unit.

When the selection of at least the one transmission information is not sensed, the information management program may proceed to operation 807 and control the display unit to display transmission information about the electronic device.

Alternatively, when the selection of at least the one transmission information is sensed, the information management program proceeds to operation 811 and transmits a data confirmation signal for corresponding data to the application program which requests transmission of the data for the transmission information to identify the data for the selected transmission information.

In the above-described one embodiment of the present disclosure, the information management program may add the transmission information provided from the application program on the management information list.

In another embodiment of the present disclosure, the information management program may generate transmission information about data transmitted to the counterpart electronic device or the server by a transmission program according to a data transmission completion signal provided from the transmission program, and may add the generated transmission information on a management information list.

Also, in the above-described one embodiment of the present disclosure, when the selection of the transmission information is sensed, the information management program transmits the data confirmation signal to the application program which generates the selected transmission information.

In another embodiment of the present disclosure, when selection of transmission information is sensed, the information management program may extract data for the selected transmission information from a data storing unit and execute the extracted data.

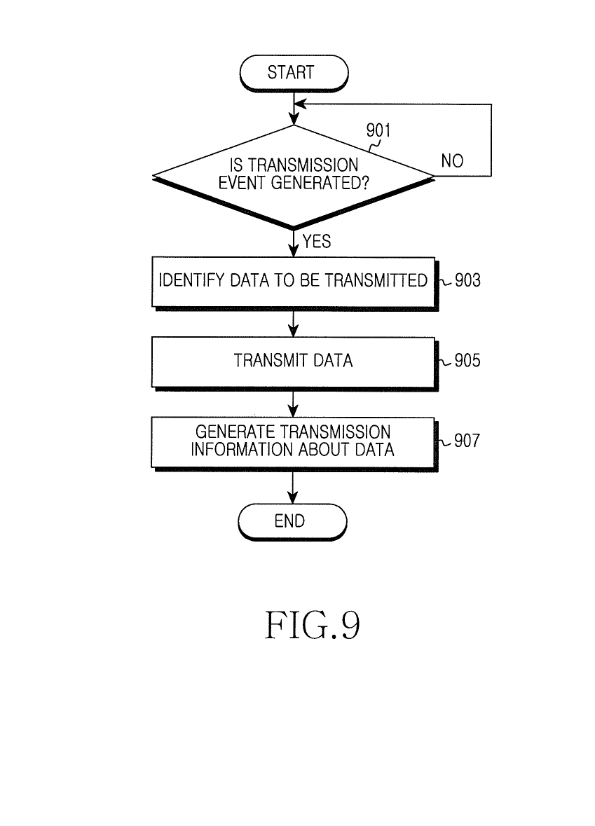

FIG. 9 illustrates a process of managing transmission information about data in a transmission program of an electronic device according to one embodiment of the present disclosure.

Referring to FIG. 9, the transmission program of the electronic device identifies whether a transmission event is generated in operation 901. For example, the electronic device may identify whether a transmission menu for a specific file is selected according to input information provided from an input device.

When the transmission event is generated, the transmission program proceeds to operation 903 and identifies data according to the transmission event. For example, the transmission program may extract data according to the transmission event from a data storing unit.

After identifying the data to be transmitted, the transmission program proceeds to operation 905 and transmits the data according to the transmission event to a counterpart electronic device or a server.

Thereafter, the transmission program proceeds to operation 907 and generates transmission information about the data transmitted to the counterpart or the server. Herein, the transmission program may store the transmission information about the data in the data storing unit.

In the above-described one embodiment of the present disclosure, the transmission program may generate the transmission information about the data transmitted to the counterpart electronic device or a server and store the generated transmission information in the data storing unit. Accordingly, executing an application program, the electronic device may add and display the transmission information to the data transmitted to the counterpart electronic device or the server in consideration of transmission information stored in the data storing unit.

In another embodiment of the present disclosure, the transmission program may transmit the transmission information about the data transmitted to the counterpart electronic device or the server to an information management program.

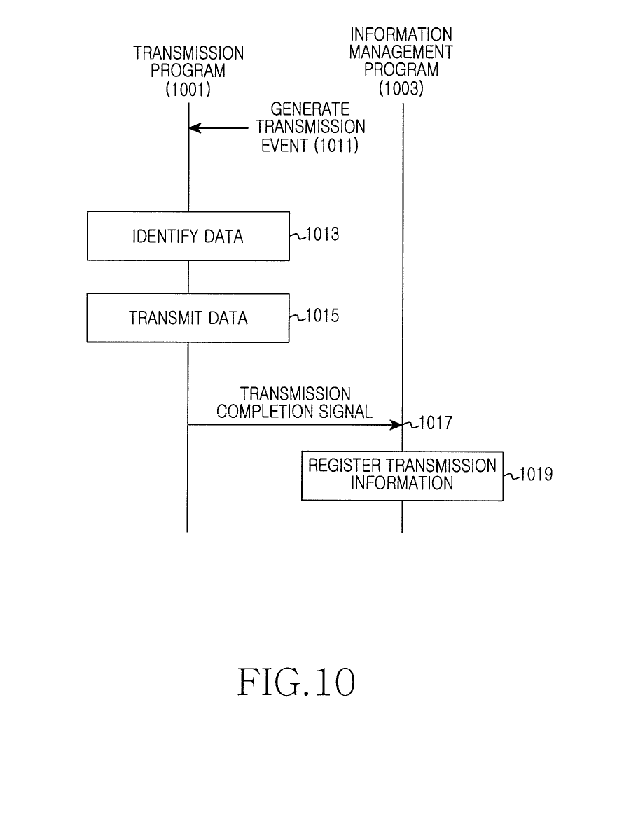

FIG. 10 illustrates a signal sequence diagram of a process of managing transmission information about data using an information management program in an electronic device according to another embodiment of the present disclosure.

Hereinafter, a description will be given for transmitting and receiving signals at a transmission program and an information management program which are installed in the electronic device. Also, a transmission controller for executing a transmission program and an information managing unit for executing an information management program may transmit and receive signals according to configuration of the electronic device.

As shown in FIG. 10, when a transmission event is generated (operation 1011), a transmission program 1001 of the electronic device identifies data to be transmitted to a counterpart electronic device or a server according to the transmission event (operation 1013). For example, the transmission program 1001 may extract data to be transmitted to the counterpart electronic device or the server according to the transmission event from a data storing unit.

Thereafter, the transmission program 1001 transmits data according to the transmission event to the server or the counterpart electronic device (operation 1015).

When the transmission of the data is completed, the transmission program 1001 transmits a data transmission completion signal to an information management program 1003 (operation 1017).

Receiving the data transmission completion signal from the transmission program 1001, the information management program 1003 generates transmission information about the data transmitted to the counterpart electronic device or the server through the transmission program 1001 (operation 1019). Thereafter, the information management program 1003 may add and store the transmission information about the data on a management information list. For one example, managing schedule information, the information management program 1003 may add the transmission information to the schedule information. For another example, managing diary information of a user, the information management program 1003 may add the transmission information to the diary information of the user. For another example, managing phonebook information, the information management program 1003 may add the transmission information to counterpart electronic device information included in a phonebook.

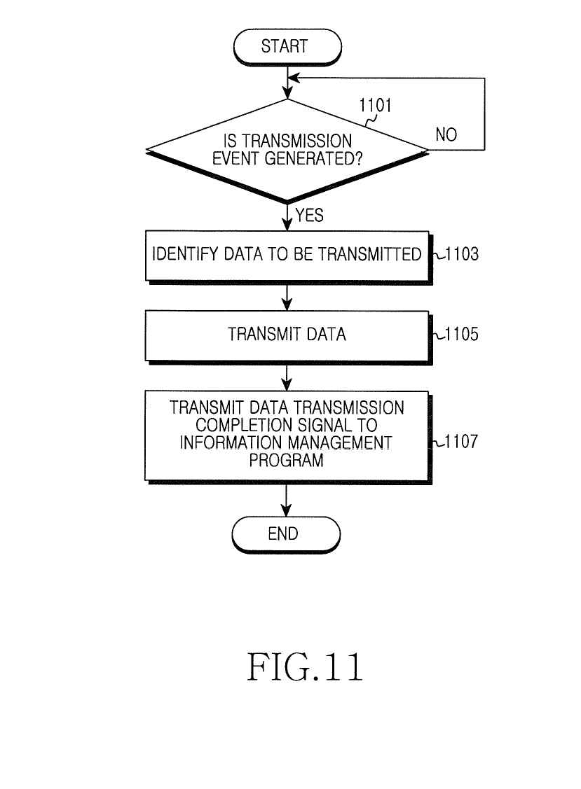

FIG. 11 illustrates a flowchart illustrating a process of transmitting transmission information about data in a transmission program of an electronic device according to one embodiment of the present disclosure.

Referring to FIG. 11, the transmission program of the electronic device identifies whether a transmission event is generated in operation 1101. For example, the electronic device may identify whether a transmission menu for a specific file is selected according to input information provided from an input device.

When the transmission event is generated, the transmission program proceeds to operation 1103 and identifies data according to the transmission event. For example, the transmission program may extract data according to the transmission event from a data storing unit.

After identifying the data to be transmitted, the transmission program proceeds to operation 1105 and transmits the data according to the transmission event to a counterpart electronic device or a server.

Thereafter, the transmission program proceeds to operation 1107 and transmits a data transmission completion signal for the data transmitted to the counterpart electronic device or the server to an information management program.

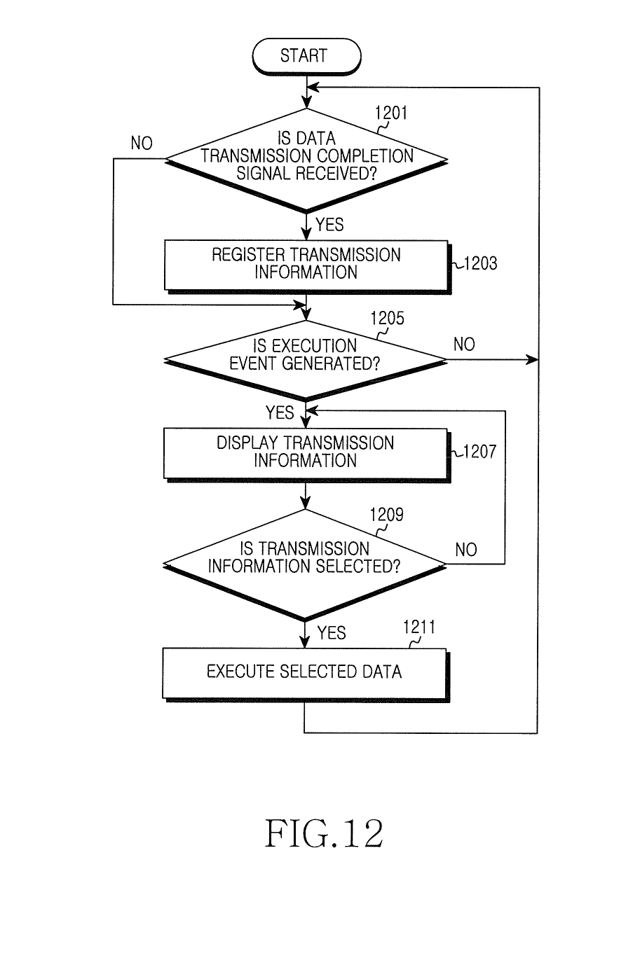

FIG. 12 illustrates a process of managing transmission information about data in an information management program of an electronic device according to another embodiment of the present disclosure.

Referring to FIG. 12, the information management program of the electronic device identifies whether a data transmission completion signal is received from a transmission program in operation 1201.

Not receiving the data transmission completion signal, the information management program proceeds to operation 1205 and identifies whether an execution event is generated. For example, the information management program identifies whether its selection is sensed by input information provided from an input device.

Alternatively, receiving the data transmission completion signal, the information management program proceeds to operation 1203 and generates and registers transmission information about data transmitted to a counterpart electronic device or a server through the transmission program. For one example, managing schedule information, the information management program may add the transmission information to the schedule information. For another example, managing diary information of a user, the information management program may add the transmission information to the diary information of the user. For another example, managing phonebook information, the information management program may add the transmission information to counterpart electronic device information included in a phonebook.

Thereafter, the information management program proceeds to operation 1205 and identifies whether an execution event is generated. For example, the information management program identifies whether its selection is sensed by input information provided from the input device.

When the execution event is not sensed, the information management program proceeds to operation 1201 and identifies whether a data transmission completion signal is received from the transmission program.

Alternatively, when the execution event is sensed, the information management program proceeds to operation 1207 and displays the transmission information about the electronic device. For one example, managing schedule information, the information management program may control, as shown in FIG. 15A, a display unit to display schedule information 1500 including transmission information. In addition, the information management program may control the display unit to display transmission information about a specific date on a lower end 1510 of schedule information. When a date 1500 in which transmission information is displayed is selected, the information management program may control, as shown in FIG. 15B, to display transmission information 1520 about at least one data which is transmitted to a counterpart electronic device or a server at a specific date.

In addition, the information management program proceeds to operation 1209 and identifies whether selection of at least one of transmission information displayed on the display unit is sensed.

When the selection of at least the one transmission information is not sensed, the information management program may proceed to operation 1207 and control the display unit to display the transmission information about the electronic device.

Alternatively, when the selection of at least the one transmission information is sensed, the information management program proceeds to operation 1211, extracts data according to the selected transmission information from a data storing unit, and executes the extracted data. For example, when selection of transmission information about a “first photo” is sensed among transmission information generated on Jul. 25, 2012, the information management program extracts the “first photo” from the data storing unit and, as shown in FIG. 15B, controls the display unit to display the “first photo”.

In the above-described one embodiment of the present disclosure, when the selection of the transmission information is sensed, the information management program may execute the data according to the selected transmission information.

In another embodiment of the present disclosure, when the selection of the transmission information is sensed, the information management program may control the display unit to display detailed information about the selected transmission information. For example, when transmission information about the “first photo” is selected among the transmission information generated on Jul. 25, 2012 shown in FIG. 15B, the information management program may control, as shown in FIG. 14B, the display unit to display detailed information 1410 about a “first photo”.

Hereinafter, a description will be given for a method of controlling data transmitted to a server using an application program or an information management program in an electronic device.

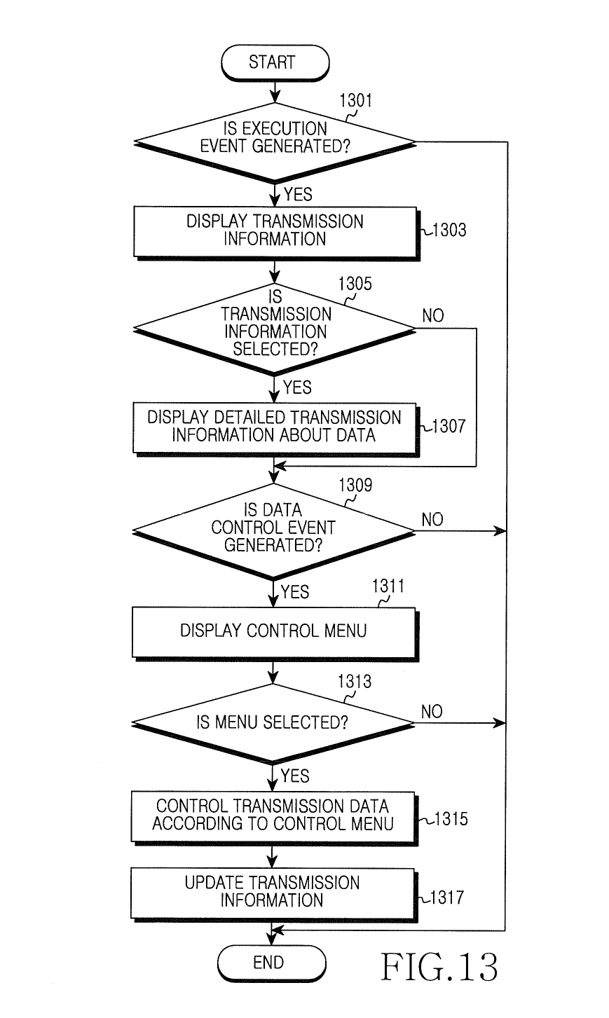

FIG. 13 illustrates a process of controlling data in an electronic device according to one embodiment of the present disclosure.

Referring to FIG. 13, the electronic device identifies whether an application program execution event is generated in operation 1301. For example, the electronic device may identify whether selection of a specific application program is sensed according to input information provided from an input device.

When the application program execution event is not generated, the electronic device ends the algorithm of FIG. 13.

Alternatively, when the application program execution event is generated, the electronic device proceeds to operation 1303 and displays transmission information about data on a display unit. For one example, when a photo management program is executed, the electronic device displays, as shown in FIG. 14A, a photo file list on the display unit. Herein, the electronic device may display transmission information 1400 on a photo file transmitted to a server by a transmission event among photo files included in the photo file list. For another example, when a schedule management application program is executed, the electronic device may display, as shown in FIG. 15A, schedule information 1500 including transmission information on the display unit. In addition, the electronic device may display transmission information registered at a specific date on a lower end 1510 of schedule information.

Thereafter, the electronic device proceeds to operation 1305 and identifies whether selection of the transmission information is sensed.

When the selection of the transmission information is not sensed, the electronic device proceeds to operation 1309 and identifies whether a data control event is generated. For example, the electronic device may identify whether a data control menu is selected according to input information provided from the input device.

Alternatively, when the selection of the transmission information is sensed, the electronic device proceeds to operation 1307 and displays detailed transmission information about data on the display unit. For one example, when selection of transmission information 1400 of a photo file shown in FIG. 14A is sensed, the electronic device may display, as shown in FIG. 14B, detailed transmission information 1410 about a photo file. For another example, when selection of schedule information 1500 (e.g., Jul. 25, 2012) including transmission information shown in FIG. 15A is sensed, the electronic device may display, as shown in FIG. 15B, detailed transmission information 1520 generated on “Jul. 25, 2012”. For another example, when selection of transmission information about a “first photo” is sensed among transmission information generated on Jul. 25, 2012 shown in FIG. 15B, the electronic device may display, as shown in FIG. 14B, detailed transmission information 1410 for a “first photo” on the display unit.

Thereafter, the electronic device proceeds to operation 1309 and identifies whether a data control event for at least one data transmitted to the server is generated. For one example, the electronic device identifies whether a data control menu is selected in a state where specific data is selected. For another example, after the data control menu is selected, the electronic device may identify whether specific data for control is selected.

When the data control event is not generated during a reference time, the electronic device recognizes that a control event for data transmitted to the server is not generated. Accordingly, the electronic device ends the algorithm of FIG. 13.

Alternatively, when the data control event is generated, the electronic device proceeds to operation 1311 and displays a data control menu. For example, the electronic device displays a pop-up window including the data control menu on the display unit. Herein, the data control menu may include at least one of a deletion menu, a correction menu, and a change menu for sharing data.

Thereafter, the electronic device proceeds to operation 1313 and identifies whether selection of the data control menu is sensed. For example, the electronic device identifies whether a control menu of any one of the deletion menu, the correction menu, and the change menu displayed on the pop-up window is selected.

When the control menu is not selected during a reference time, the electronic device recognizes that an event for data control is not generated. Thereafter, for one example, the electronic device ends the algorithm of FIG. 13. For another example, the electronic device may proceed to operation 1303 and display transmission information.

Alternatively, when the control menu is selected, the electronic device may proceed to operation 1315 and control data transmitted to the server according to the control menu selected in operation 1313. That is, the electronic device may control data transmitted to the server through a background operation by an application program which displays transmission information without using a separate application program for controlling data registered in the server. For example, when a deletion menu for a “first photo” uploaded to a cloud server is selected, the electronic device may delete a “first photo” file uploaded to the cloud server through a background operation. That is, the electronic device may delete a “Yuna photo” file without displaying a screen for a cloud service on the display unit. Herein, the electronic device may delete the “first photo” file using an identifier of the “first photo” file in the cloud server, which is recognized when uploading a “first photo” to the cloud server.

Thereafter, the electronic device proceeds to operation 1317 and updates transmission information stored in a data storing unit according to control information of data. For one example, when the “first photo” file uploaded to the cloud server is deleted, the electronic device may delete transmission information about a “first photo” transmitted to the cloud server from the data storing unit. For another example, the electronic device may add deletion information of the “first photo” file about the cloud server to the data storing unit.

As described above, the electronic device stores and displays the transmission information about the data. Accordingly, the user of the electronic device may easily identify the transmission information about the data transmitted to the counterpart electronic device or the server.

Also, the electronic device may easily control the data registered in the server by controlling (changing/correcting/deleting) the data registered in the server using the application program which manages the transmission information about the data.

While the present disclosure has been particularly shown and described with reference to example embodiments thereof, it will be understood by those skilled in the art that various changes in form and details may be made therein without departing from the spirit and scope of the present disclosure as defined by the appended claims.

What is claimed is:

1. A method in an electronic device, the method comprising:
transmitting data using a first application program;
generating transmission information about the data transmitted using the first application program; and
displaying the transmission information about the data.

2. The method of claim 1, wherein the transmission of the data comprises:
transmitting a request for transmitting the data to a second application program at the first application program when a transmission event for the data is generated while the first application program is executed; and
transmitting the data to at least one counterpart electronic device or at least one server at the second application program according to the request of the first application program.

3. The method of claim 2, wherein the generation of the transmission comprises generating the transmission information about the data at the first application program when the first application program receives a transmission completion signal for the data from the second application program.

4. The method of claim 1, wherein the transmission information comprises at least one of a transmission target of the data, a transmission time of the data, a kind of the data, information of a transmission program which transmits the data, and information of the first application program.

5. The method of claim 1, wherein the display of the transmission information comprises displaying a transmission information icon on data information in a file list when the file list comprising the data information is displayed based on execution of the first application program.

6. The method of claim 1, further comprising:
transmitting the transmission information to a third application program after the transmission information is generated; and
displaying the transmission information on a service screen corresponding to the third application program when the third application program is executed.

7. The method of claim 6, wherein the third application program comprises at least one of a schedule management program, a phonebook program, and a diary program.

8. The method of claim 1, further comprising:
identifying a control command corresponding to a control event when the control event is generated for data transmitted to a server is generated; and
transmitting the control command to the server.

9. The method of claim 8, wherein the control command comprises at least one of a deletion command and a correction command for data.

10. An electronic device comprising:
a display unit;
at least one processor;
a memory; and
at least one program which is stored in the memory and is executed by the at least one processor,
wherein the at least the one processor is configured to transmit data using a first application program among the at least one program, generate transmission information about the transmitted data, and display the transmission information about the data on the display unit.

11. The electronic device of claim 10, wherein the at least one processor is configured to execute a second application program among the at least one programs when a transmission event for the data is generated while the first application is executed and transmits the data corresponding to the transmission event to at least one counterpart electronic device or at least one server.

12. The electronic device of claim 11, wherein the at least one processor is configured to execute the first application program and generate transmission information about the data when the transmission of the data is completed through the second application program.

13. The electronic device of claim 10, wherein the transmission information comprises at least one of a transmission target of the data, a transmission time of the data, a kind of the data, information of a transmission program which transmits the data, and information of the first application program.

14. The electronic device of claim 10, wherein the display unit is configured to display a transmission information icon on data information in a file list when the file list comprising the data information is displayed on the display unit based on execution of the first application program.

15. The electronic device of claim 10, wherein the display unit is configured to display the transmission information generated when the at least one processor executes the first application program on a service screen corresponding to a third application program when the third application program among at least the one program is executed.

16. The electronic device of claim 15, wherein the third application program comprises at least one of a schedule management program, a phonebook program, and a diary program.

17. The electronic device of claim 10, wherein the at least one processor is configured to transmit a control command corresponding to a control event to a server when the control event for data transmitted to the server is generated after the transmission information is displayed.

18. The electronic device of claim 17, wherein the control command comprises at least one of a deletion command and a correction command for data.

19. A method in an electronic device, the method comprising:
transmitting at least one data;
generating at least one transmission information about the at least the one data;
displaying the at least the one transmission information; and
transmitting any one of deletion and correction control commands for the at least one data corresponding to a control event to a server when the control event for the at least one data transmitted to the server among at least the one data is generated.

20. The method of claim 19, wherein the at least one transmission information comprises at least one of a transmission target of the data, a transmission time of the data, a kind of the data, information of a transmission program which transmits the at least one data, and information of a first application program.
